(19) United States
(12) Patent Application Publication
(10) Pub. No.: US 2017/0212511 A1
(43) Pub. Date: Jul. 27, 2017

(54) DEVICE AND METHOD FOR SELF-AUTOMATED PARKING LOT FOR AUTONOMOUS VEHICLES BASED ON VEHICULAR NETWORKING

(71) Applicants: UNIVERSIDADE DO PORTO, Porto (PT); INSTITUTO DE TELECOMUNICACOES, Lisboa (PT); GEOLINK, LDA, Porto (PT); CARNEGIE MELLON UNIVERSITY, Pittsburg, PA (US)

(72) Inventors: Michel Celestino PAIVA FERREIRA, Porto (PT); Luís Manuel MARTINS DAMAS, Porto (PT); Hugo Marcelo FERNANDES DA CONCEIÇÃO, Porto (PT); Pedro MIRANDA DE ANDRADE DE ALBUQUERQUE D'OREY, Porto (PT); Peter STEENKISTE, Pittsburgh, PA (US); Pedro Emanuel RODRIGUES GOMES, Porto (PT); Ricardo Jorge FERNANDES, Porto (PT)

(73) Assignees: UNIVERSIDADE DO PORTO, Porto (PT); Instituto de Telecomunicações, Lisboa (PT); GEOLINK, LDA, Porto (PT); CARNEGIE MELLON UNIVERSITY, Pittsburg, PA (US)

(21) Appl. No.: 15/115,453

(22) PCT Filed: Jan. 30, 2015
(86) PCT No.: PCT/IB2015/050736

§ 371 Date: Jul. 29, 2016

(30) Foreign Application Priority Data
Jan. 30, 2014 (PT) 107440

(51) Int. Cl. G05D 1/00; G07C 5/00; G05D 1/02; G08G 1/14; H04L 29/08

(52) U.S. Cl. CPC G05D 1/0027; G08G 1/143; H04L 67/12; G05D 1/0291; G07C 5/008

(57) ABSTRACT

The present disclosure relates to a device and a method for self-automated parking lots for autonomous vehicles based on vehicular networking, advantageous in reducing parking movements and space. It is described a device for self-automated parking lot for autonomous vehicles based on vehicular networking, comprising: a vehicle electronic module for receiving, executing and reporting vehicle movements, a parking lot controller for managing and coordinating a group of vehicles in parking and unparking maneuvers, the vehicle module and controller comprising a vehicular ad hoc networking communication system. It is also described a method comprising moving autonomously in platoon one or more rows of already parked vehicles in order to make available a parking space for a vehicle arriving to the parking space; and moving autonomously in platoon one or more rows of parked vehicles in order to make a parked vehicle able to exit the parking space.

### TECHNICAL FIELD

The present disclosure relates to a device and a method for self-automated parking lots for autonomous vehicles based on vehicular networking.

### BACKGROUND ART

Parking is a major problem of car transportation, with important implications in traffic congestion and urban landscape. Reducing the space needed to park cars has led to the development of fully automated and mechanical parking systems. These systems are, however, limitedly deployed because of their construction and maintenance costs. The following are relevant references:
[1] Chris Urmson, Joshua Anhalt, Drew Bagnell, Christopher Baker, Robert Bittner, M N Clark, John Dolan, Dave Duggins, Tugrul Galatali, Chris Geyer, et al. Autonomous driving in urban environments: Boss and the urban challenge. Journal of Field Robotics, 25(8):425-466, 2008.
[2] John Markoff. Google cars drive themselves, in traffic. The New York Times, 10:A1, 2010.
[3] Donald C Shoup. Cruising for parking. Transport Policy, 13(6):479-486, 2006.
[4] Donald C Shoup. The high cost of free parking, volume 7. Planners Press, American Planning Association Chicago, 2005.
[5] Monroe County. Statistical analyses of parking by land use. Technical report, Department of Planning and Development, August 2007.
[6] Derek Edwards. Cars kill cities. Progressive Transit Blog, January 2012.
[7] ETSI TC ITS. Intelligent Transport Systems (ITS); Vehicular Communications; Basic Set of Applications; Part 2: Specification of Cooperative Awareness Basic Service. Technical Report TS 102 637-2 V1.2.1, 2011.
[8] Murat Caliskan, Daniel Graupner, and Martin Mauve. Decentralized discovery of free parking places. In Proceedings of the 3rd International Workshop on Vehicular Ad Hoc Networks, pages 30-39, 2006.
[9] Jos N. van Ommeren, Derk Wentink, and Piet Rietveld. Empirical evidence on cruising for parking. Transportation Research Part A: Policy and Practice, 46(1):123-130, 2012.
[10] T. Rajabioun, B. Foster, and P. Ioannou. Intelligent Parking Assist. In 21st Mediterranean Conference on Control Automation, pages 1156-1161, 2013.
[11] A. Grazioli, M. Picone, F. Zanichelli, and M. Amoretti. Collaborative Mobile Application and Advanced Services for Smart Parking. In IEEE 14th International Conference on Mobile Data Management (MDM), volume 2, pages 39-44, 2013.
[12] Bo Xu, O. Wolfson, Jie Yang, L. Stenneth, P. S. Yu, and P. C. Nelson. Real-Time Street Parking Availability Estimation. In IEEE 14th International Conference on Mobile Data Management, volume 1, pages 16-25, 2013.
[13] J. K. Suhr and H. G. Jung. Sensor fusion-based vacant parking slot detection and tracking. IEEE Transactions on Intelligent Transportation Systems, pages 1-16, 2013. In Press.
[14] Mingkai Chen, Chao Hu, and Tianhai Chang. The Research on Optimal Parking Space Choice Model in Parking Lots. In 3rd International Conference on Computer Research and Development, volume 2, pages 93-97, 2011.
[15] Raymond J. Brown et al. Four wheels on jacks park car. Popular Science, 125(3):58, September 1934.
[16] D. C. Conner, H. Kress-Gazit, H. Choset, A. A. Rizzi, and G. J. Pappas. Valet Parking without a Valet. In IEEE/RSJ International Conference on Intelligent Robots and Systems, pages 572-577, 2007.
[17] Kyoungwook Min, Jeongdan Choi, Hangeun Kim, and Hyun Myung. Design and Implementation of Path Generation Algorithm for Control-ling Autonomous Driving and Parking. In 12th International Conference on Control, Automation and Systems, pages 956-959, 2012.
[18] Michel Ferreira, Ricardo Fernandes, Hugo Conceicao, Wantanee Viriyasitavat, and Ozan K Tonguz. Self-organized traffic control. In Proceedings of the seventh ACM international workshop on VehiculAr InterNETworking, pages 85-90. ACM, 2010.
[19] Kees Jan Roodbergen and Iris F A Vis. A survey of literature on automated storage and retrieval systems. European Journal of Operational Research, 194(2):343-362, 2009.
[20] Matt Jancer. Take a look inside the first steer-by-wire car. Wired, May 2013. http://www.wired.com/autopia/2013/05/al_drivebywire/. Accessed: Jan. 2, 2013.
[21] Igor E Paromtchik and Christian Laugier. Autonomous parallel parking of a nonholonomic vehicle. In Intelligent Vehicles Symposium, 1996., Proceedings of the 1996 IEEE, pages 13-18. IEEE, 1996.
[22] Maxim Raya and Jean-Pierre Hubaux. Securing vehicular ad hoc networks. Journal of Computer Security, 15(1):39-68, 2007.
[23] Marta C Gonzalez, Cesar A Hidalgo, and Albert-Laszlo Barabasi. Understanding individual human mobility patterns. Nature, 453(7196):779-782, 2008.
[24] Ricardo Fernandes, Fausto Vieira, and Michel Ferreira. Vns: An integrated framework for vehicular networks simulation. In Vehicular Networking Conference (VNC), 2012 IEEE, pages 195-202. IEEE, 2012.
[25] American Automobile Association. Your driving costs, 2013 edition. AAA Association Communication, 2013.

### General Description

Leveraging on semi and fully-autonomous vehicular technology, as well as on the electric propulsion paradigm and in vehicular ad hoc networking, we propose a new parking concept where the mobility of parked vehicles is managed by a parking lot controller to create space for cars entering or exiting the parking lot, in a collaborative manner. We show that the space needed to park such vehicles can be reduced to half the space needed with conventional parking lot designs. We also show that the total travelled distance of vehicles in this new parking lot paradigm can be 30% less than in conventional parking lots. Our proposal can have important consequences in parking costs and in urban landscape.

Autonomously-driven cars are only a few years away from becoming a common feature on our roads [1], [2]. These self-driven vehicles hold the potential to significantly change urban transportation. One of the most important changes will not happen during the trip from origin to destination, but rather when these vehicles arrive at their destinations. An autonomous vehicle will leave its passengers at their destination and will then park by itself, waiting to be called to pick them up later on. This behaviour will have important implications on door-to-door trip time, traffic congestion and parking costs.

As pointed-out by Donald Shoup [3]: “A surprising amount of traffic isn't caused by people who are on their way somewhere. Rather it is caused by people who have already arrived”. Shoup refers to this phenomena as cruising for parking and shows that, despite the short cruising distances per car, this results in significant traffic congestion, wasted fuel and high CO2 emissions [4].

With autonomous vehicles, the door-to-door trip time of a passenger will not be aggravated by the cruise time needed to find a parking space, nor with the walking time needed to go from the parking space to the final destination. Furthermore, after leaving their passengers at their destinations, these autonomous vehicles can rapidly proceed to a parking lot that does not need to be at a reasonable walking distance, as happens with non-autonomous vehicles. Nevertheless, the parking of these autonomous vehicles will still face the same problems of non-autonomous vehicles, since parking space is scarce and expensive.

If we consider the average 150 square feet of a parking space, and we assume there are 250 million vehicles in the USA, then a parking lot to contain all these vehicles would measure 1350 square miles, roughly 0.04% of the country's area. This does not seem much, but the problem is the concentration of vehicles in urban areas. As urban planners know, parking space is commonly allocated at a ratio of 1 space per 200 square feet of land use for a variety of businesses [5]. If we add an extra 30-50% of space for the access ways in typical parking lots, then we actually have ratios higher than 1:1 between the space allocated for parking and the space allocated for businesses such as supermarkets, shopping centres, office buildings, or restaurants. For example, in midtown Atlanta, in Georgia, USA, the percentage of land space that is 100% dedicated to parking reaches 21% [6]. This is one of the densest and most pedestrian-friendly area in the entire state of Georgia, USA. Parking is then often the biggest land uses in many cities.

In parallel with the paradigm of autonomous vehicles, electric propulsion is also starting to be applied to automobiles. The electric motors used in Electric Vehicles (EV) often achieve 90% energy conversion efficiency over the full range of power output and can be precisely controlled. This makes low-speed parking manoeuvres especially efficient with EV.

Another technological innovation being proposed to auto-mobiles is wireless ad hoc vehicular communication, in the form of vehicle-to-vehicle (V2V) or vehicle-to-infrastructure (V2I) communication. The idea we present in this disclosure is based on the combination of autonomous vehicles, electric propulsion and wireless vehicular communication to design a new paradigm of self-automated parking lot, which maximises the number of cars that can be fitted in the parking lot space, relying solely on in-vehicle systems.

An autonomously-driven EV equipped with vehicular communications (e.g. ITS G5, 802.11p standard [7]) consults online for an available parking space in nearby self-automated parking lots. It reserves its parking space and proceeds to that location. Upon entering the parking lot, this vehicle uses V2I communication to exchange information with a computer managing the parking lot. The vehicle can give an estimate of its exit time, based on the self-learned routine of its passenger, or on an indication entered by this same passenger. The parking lot computer informs the vehicle of its parking space number, indicating the exact route to reach this parking space. As vehicles are parked in a manner that maximises space usage (no access ways), this path can require that other vehicles already parked in the parking lot are also moved. The parking lot computer also issues the wireless messages to move these vehicles, which are moved in platoon whenever possible, to minimise the parking time. The exit process is identical. Minimal buffer areas are designed in the parking lot to allow the entry/exit of any vehicle under all possible configurations. The managing computer is responsible for the design of parking strategies that minimise the miles travelled by parked vehicles on these manoeuvres.

The remainder of this disclosure is organised as follows. In the next section we provide some background on parking lot technology. Following, we describe our system design issues. In the subsequent section we present the evaluation framework to compare our proposal with a conventional parking lot, leveraging on a dataset with entry and exit times of a real parking lot in the city of Porto, Portugal. We then evaluate a simple parking strategy for our self-automated parking lot proposal, based on this dataset, and compare the key metric of travelled distance in the parking lots, to show the feasibility of our proposal. We end with some conclusions.

The following pertains to parking technology. Traffic congestion has for some decades been one of the major transportation problems due to its many and related causes. In dense urban areas, the search for an empty parking place can create considerable congestion, which results in eco-nomical losses and serious environmental impact. Searching for parking often occurs due to the imbalance between on-road and off-road parking prices, and additionally the oversupply of free parking. A survey found that parking is free for 99% of all automobile trips in the United States [4]. In a historic study [3], Shoup reported that the average share of traffic cruising for parking amounts to 30% and the average search time is 8.1 minutes. In the same report, the author found that in a small business district in Los Angeles, cruising for parking leads to an additional 950000 miles travelled, wastes 47000 gallons of gasoline and produces 730 tons of CO2 emissions. A comparable study (see [8]) conducted in a district in Munich, Germany, shows a similar trend, i.e. wastes of 3.5 million euros on fuel and 150000 hours, and 20 million euros in economical loss. Projected on larger cities in Germany, comprising multiple districts of similar sizes, a total economical damage of 2 to 5 billion Euros per year is estimated [8]. In [9], Ommeren et al. conclude that cruising time increases with travel duration as well as with parking duration, but falls with income.

The following pertains to Parking lot design. Parking also poses challenges to urban planners and architects. Considering that citizens often only use their cars to commute to and from work, the space occupied by these in urban areas is inefficiently used (e.g. currently the average car is parked 95% of the time). Additionally, urban development has to consider local regulations that mandate parking space requirements depending on the construction capacity, which increases costs and limits buyers choices as demand surpasses parking space supply. A study in 2002 has estimated that parking requirements impose a public subsidy for off-street parking in the US between $127 billion in 2002 and $374 billion [4].

In recent years, there has been an increasing interest in the design of parking structures. Parking lots consist of four main zones, namely circulation areas for vehicles and pedestrians, parking spaces, access to the parking infrastructure and ramps in multi-floor structures. Parking structure design compromises the selection of a number of parameters, such as shape (usually rectangular), space dimensions, parking angle, traffic lanes (e.g. one or two-way), access type or ramping options, depending on site constraints, regulations, function (e.g. commercial or residential), budget and efficiency reasons. Due to a number of reasons (e.g. existence of pedestrian circulation areas) parking lots for human-driven vehicles are inefficient and costly (e.g. smaller soil occupancy ratio), which is critical in densely populated areas.

The following pertains to parking systems. Extensive research has been carried out in the area of parking systems enabled by ITS. This research field is commonly classified into two main categories, namely parking assistance and automatic parking. Parking assistance systems, which are enabled by sensing, information and communication technology, support drivers by finding available on-street and/or off-street parking places. In these systems, acquired parking information (supply or demand) is disseminated to drivers, or its support systems, for decision making, i.e. parking space/route selection and eventually parking reservation and price negotiation. Examples of assistance systems are parking information system [10], [11] (e.g. guidance, space reservation), parking space detection (e.g. using GPS [12], cameras or sensors [13]), or parking space selection (e.g. based on driver preferences [14]).

Special attention has also been dedicated to the broad area of automatic parking. An early mechanical parking system [15] used four jacks to lift the car from the ground and wheels in the jacks assisted on the lateral movement towards the final parking position. One of the major examples of this category is self-parking, where vehicles automatically calculate and perform parking maneuvers using sensor information (e.g. cameras, radar) and by controlling vehicle actuators (e.g. steering). An improvement to this system is Valet Parking [16], [17] where besides self-parking, the vehicle autonomously drives until it finds an available parking place. It should be noted that the two previous systems can be used for on-road and off-road parking (e.g. parking lots).

To reduce the space necessary to park vehicles, automated robotic parking has been deployed in areas where available space is especially scarce and expensive. These parking lots use electric elevators, rolling and rotating platforms to park vehicles in multi-floor structures, maximizing the occupancy of space. The parking maneuvers are done automatically by the electric platforms, without any intervention from drivers or operators. Automated robotic solutions are readily available in the market by several manufacturers, such as Boomerang Systems (http://boomerangsystems.com/) or Parkmatic (http://www.parkmatic.com/). However, due to their complexity, these systems require high capital investments and can have considerable operational costs (e.g. maintenance or energy costs), which can result in high costs for the end user. For instance, in many urban areas, the first hour of parking in such complex parking lots can reach $20. Another drawback of this solution is the absence of the Valet Parking feature since drivers need to bring vehicles into the closest parking place, which may not be the most appropriate (e.g. in terms of costs). Furthermore, the fixed size and small number of moving platforms limits the optimally of parking space allocation.

The following pertains to system design. Our system design issues are described in this section. We address our assumptions regarding the self-driving capabilities of vehicles, the architecture and infrastructure of the parking lot, and a simple communication protocol which allows the parking lot controller to manage the mobility of the parked vehicles.

The following pertains to parking lot architecture. The geometric design of the parking lot is an important issue in our proposal. As described in the previous section, in conventional parking lots there are a number of considerations that have to be taken into account when designing them. For instance, width of parking spaces and access ways, one-way or two-way use of the access ways, entry angle in the parking bays (90°, 60°, 45°), pedestrian paths, visibility to find an available parking space, etc.

In our self-automated parking lot, many of these considerations do not apply. Manoeuvring is done autonomously by the car, pedestrian access is not allowed, and the assigned parking space is determined by the parking lot controller. The main design issue is defining a geometric layout that maximises parking space, leveraging on minimal buffer areas to make the necessary manoeuvres that allow the exit from any parking space under all occupancy configurations. This geometric design is ultimately determined by the shape of the space of the parking lot. The parking lot architecture also defines the trajectories and associated manoeuvres to enter and exit each parking space.

The parking lot has a V2I communication device which allows the communication between the vehicles and the parking lot controller. In theory, this infrastructure equipment could be replaced by a vehicle in the parking lot, which could assume the function of parking lot controller while parked there, handing over this function to another car upon exit, similarly to the envisioned functioning of a V2V Virtual Traffic Light protocol [18]. Note, however, that the existence of the actual infrastructure, which could be complemented with a video-camera offering an aerial perspective of the parking lot to improve the controller perception of the location and orientation of vehicles, could simplify the protocol and improve reliability.

Reducing and simplifying such trajectories and manoeuvres is also an important design issue, as they affect the reliability of the system and allow faster storage and retrieval of cars. Note also that the parking lot architecture can take advantage of the fact that the passenger is not picking up the car at the parking lot, but it is rather the car that will pick up the passenger. This allows having different exits at the parking lot, which are selected based on the current location of the car. To optimise and simplify manoeuvres, these self-automated parking lots will require specific minimum turning radius values for vehicles. Only vehicles that meet the turning radius specified by each parking lot will be allowed to enter it.

The geometric layout of the parking lot and its buffer areas can assume very different configurations for the self-automated functioning. In particular, even parking areas which are not seen today as formal parking lots, such as double curb parking, could be managed by a similar parking lot controller.

As a proof-of-concept example, we provide the parking lot design illustrated in FIG. 1. This parking lot has a total of 10×10 parking spaces, and two buffer areas, one to the left of the parking spaces, and one to the right, measuring 6 m×20 m. The size of the buffer area is determined by a minimum turning radius which was assumed to be 5 m in this example, a typical value for midsize cars. As this parking lot is designed for autonomous vehicles, which enter it after leaving their passengers, it is not necessary to leave the inter-vehicle space that allows the doors to be opened. Thus, the width of the parking spaces can be significantly reduced (≈−20%). In this example, we use 2 m×5 m for each parking space.

This space-saving layout requires a specific strategy to guide the insertion and removal of vehicles. Ultimately, a layout is only feasible as long as the required movement by the vehicles does not have a significant cost. Next, we demonstrate a simple algorithm that exploits the exemplified layout. Later, in Section V we evaluate its performance.

The following pertains to entry/exit algorithm. Consider FIG. 1. In this self-automated parking lot design, in order to simplify and standardise the manoeuvres, we use the buffer areas simply to allow the transfer of a vehicle from a given row to a new row which is 5 positions up or above (as dictated by the minimum turning radius of 5 m), as illustrated by the semi-circle trajectories depicted in FIG. 1. This transfer of a vehicle from one row r to another r′ will eventually require that other vehicles are moved and re-inserted in r, in a carrousel fashion. This usage of the buffer areas is not particularly efficient from the point of view of space usage or mobility minimisation, but enables us to define a simple manoeuvring strategy of the parking lot that allows the exit of any vehicle. In this architecture we allow vehicles to enter/exit the parking lot through the left or right of the parking area.

A simple algorithm can then be defined as following:
On Vehicle Entry: the vehicle is directed to the left-most row r with an empty space, such that the eventual movement by the vehicles already in r and r′, to allow the entry of the vehicle, is minimised. The vehicle is placed in the furthest empty space in r.
On Vehicle Exit: the exiting vehicle parked in row r is directed to exit from the front or back, such that the eventual movement by the vehicles in r and r′, to create an open path, is minimised.

The following pertains to self-driving capabilities. In the specific case of our self-automated parking lot proposal, the autonomous driving capabilities of vehicles involve much simpler tasks than in the case of driving on public roads. First of all, because the environment is fully managed by the parking lot controller and the only mobility that exists in the parking lot is determined by this controller. It is thus a fully robotised environment, where there is no interaction between autonomous vehicles and human-driven vehicles. In terms of technology and complexity, our setup is much more similar to Automated Storage and Retrieval Systems (AS/RSs), which have widely been used in distribution and production environments since its deployment in the 1950s [19], than to generic autonomous driving on public roads.

Given that the parking lot controller coordinates all mobility in the parking lot, it knows the current configuration of the parking lot at all times. Thus, all the computer-vision technology, which plays an important part in autonomous driving, is not necessary in this controlled environment. More than self-driving capabilities, the cars that use the self-automated parking lot need to have a system to enable their remote control (through DSRC radios) at slow speeds in this restricted environment. Drive-by-wire (DbW) technology, where electrical systems are used for performing vehicle functions traditionally achieved by mechanical actuators, enables this remote control to be easily implemented. Throttle-by-wire is in widespread use in modern cars and the first steering-by-wire production cars are also already available [20]. EV will be an enabling factor for DbW systems because of the availability of electric power for the new electric actuators.

The precise localisation of vehicles is an important issue. In addition to global positioning systems, such as GPS, and to the aerial camera images, inertial systems from each car are also used to convey to the parking lot controller precise information about the displacement of each vehicle. This information can even report per wheel rotations, capturing the precise trajectories in turning manoeuvres.

Note that these limited requirements on the self-driving capabilities of the involved cars, would allow extending applicability of the self-automated parking lot to non-autonomous or semi-autonomous vehicles, which are left at the entrance of the parking lots by their drivers. While fully-autonomous production cars are still non-existent, automatic parking sys-tems are already available in a number of production cars, based on research to control parallel parking manoeuvres of nonholonomic vehicles [21].

The following pertains to communication protocol. The communication protocol for the self-automated parking lot establishes communication between two parties: the parking lot controller (PLC) and each vehicle.

A vehicle trying to enter the parking lot, first queries the PLC for its availability. The PLC has a complete view of the parking lot state, mapping a vehicle to a parking space, and responds affirmatively if it is not full. Upon entering the parking lot, the autonomous vehicle engages in PLC-mode. During the stay in the parking lot, the PLC is responsible for managing the mobility of the vehicle. To move a vehicle, the PLC sends movement instructions in the form of a sequence of commands, similar to the commands used in radio-controlled cars, that will lead to the desired parking space. For example, the carousel manoeuvre described in Section IV-A corresponds to the following sequence: forward m1, steer d°, forward m2, steer −d°, forward m1. The commands depend on the vehicle attributes. These must be sent to the PLC when the vehicle enters the parking lot, i.e., width, length, turning radius, etc.

The protocol involves periodic reports sent by the vehicle to the PLC about the execution of each command (typically with the same periodicity of VANET beacons [7]). These periodic reports allow the PLC to manage several vehicles in the parking lot at the same time. Note that in order for a vehicle to be inserted in a parking space, other vehicles may need to be moved. Note also that concurrent parking can occur in different parking spaces in the parking lot. Based on the periodic reports, the PLC tries to move vehicles in a platoon fashion, whenever applicable, in order to minimise manoeuvring time.

A vehicle exit is triggered by a message sent to the PLC by the vehicle intending to exit (possibly after receiving a pickup request from its owner). The PLC then computes the movement sequence commands and sends these sequences to the involved vehicles.

Having an external controller managing the vehicles poses evident security issues. As explained in [22], vehicular net-work entities will be certified by Certification Authorities, e.g., governmental transportation authorities, involving the certification of the PLC communication device of each parking lot. Temper-proof devices may avoid or detect deviations from the correct behavior. In the ultimate case, certifications may be revoked and new vehicles will not enter the park. For the parked vehicles that will not be able to detect the certificate revocation, no high risks exist.

The following pertains to the evaluation framework. In this section we describe a conventional parking lot layout and the layout used for our proposal of a self-automated parking lot. Our goal is to compare equivalent parking lots in terms of the number of vehicles that they can hold, using two important metrics: area per car; and total traveled distance in parking and exiting manoeuvres. The actual evaluation of this last metric using a real entry/exit dataset is done in the next section.

The following pertains to a conventional parking lot. For a comparative evaluation we use a conventional parking lot design, illustrated in FIG. 2. The design of this parking lot is based on a standard layout that tries to maximise parking space and minimise access way space, similar to the one seen in the dataset video, which we will discuss further ahead. We use the common measures of 5 m×2.5 m for a parking space and a width of 6 m for the access way. Typically, two rows are placed facing each other, forcing cars to exit the parking space through a backup manoeuvre. The access way is based on a one-way lane, reducing its width and forcing cars to completely traverse the parking lot, in a standard sequence that consists of entering the parking lot, traversing it to find a parking space, parking, backing up to leave the parking space, and traversing the parking lot to proceed to the exit. This design allows us to discard variations in travelled distance when finding a vacant parking space is not deterministic.

This parking lot holds 100 cars and occupies an area of 72 m×32 m=2304 m². This yields an area per car of 23.04 m².

In this type of parking lot all vehicles traverse the same distance. The components of this distance are marked in FIG. 2. A represents the straight distances travelled in the access way, while B represents the curves. C denotes the entering and exiting manoeuvre in the parking space. Using a turning radius of 5 m, we obtain the following total traversing distance for a car: A=94.8 m, B=6×(2π×5 m)/4, C=2×(2π×5 m)/4+2×3 m. This yields a total of ≈164 m traversed by each car. It is clear that the manoeuvring model to derive such distance is over-simplified, but it results in negligible differences in our problem.

The following pertains to a self-automated parking lot. For the self-automated parking lot we use the layout de-scribed previously. To be as equivalent as possible to the parking lot in FIG. 2, we use the N_{c}=10 columns and Nᵣ=10 rows, forming a 10×10 array, comprising parking spaces, illustrated in FIG. 1. Two buffer areas are also included, with a width of 6 m each, as in the access way of the conventional parking lot. As this parking lot is designed for autonomous vehicles, which enter it after leaving their passengers, it is not necessary to leave the inter-vehicle space that allows the doors to be opened. Thus, the width of the parking spaces is reduced to 2 m. The length of each parking space is again of 5 m. The total area of this parking lot is therefore 62×20 m=1240 m², yielding an area per car of 12.40 m². This represents a reduction of nearly 50% when compared to the area per car of the conventional parking lot.

In this self-automated parking lot the traveled distance can vary substantially from car to car, contrary to what happened in the conventional parking lot. As the autonomous vehicle leaves the parking lot to collect passengers at their location, we allow it to leave the parking lot either through the left or right buffer areas. It can also exit through a backup manoeuvre. Instead of deriving a single total distance traveled by each car, as in the conventional parking lot, we can try to derive the average distance that is travelled by each vehicle under special configurations of the parking lot. Note that vehicles will not be stopped in a fixed parking space, as the managing algorithm will move them to create the access ways during entries and exits of other vehicles.

To have an idea of the magnitude of the travelling distance in this self-automated parking lot, we can compute the entry and park distance for a special case where the parking lot fills completely in a monotonic process (i.e. no exits are observed). Let β=6 m be the length of the entry buffer, and γ=5 m the length of a parking space. Assume vehicles enter through the left buffer area of the parking lot. The first N_{c} vehicles fill the furthest column, travelling a total of N_{c}(β+N_{c}γ)=560 m. The next N_{c} vehicles fill the previous column, travelling a total of 10(β+9γ)=510 m. Iteratively, the total distance in meters to fill the parking lot is thus:

$${\sum }_{i = 1}^{10} 10 ( β + i γ )$$

which gives 3350 m, or an average of 33.5 m per vehicle. This value is exactly the same that would be obtained if vehicles would park at the first available column, moving forward as necessary to accommodate entering vehicles, as described in Section IV-B. With a completely filled parking lot, the average travelled distance for the exit of each vehicle depends on the algorithm that creates exit ways by using the buffer areas. One possible alternative is to use the buffer areas as described previously, allowing vehicles to execute semi-circle trajectories based on their turning radius. If we use a turning radius of 5 m, as in the conventional parking lot, then these semi-circle trajectories join line 1 to line 6, line 2 to line 7, etc, as illustrated in FIG. 3. If the red vehicle shown in frame A of FIG. 3 wants to exit, then all vehicles in lines 1 and 6 have to rotate clockwise using the semi-circle trajectories where necessary, until the red vehicle has no vehicles blocking it, as illustrated in frame B of FIG. 3. Note that the rotation can be counter-clockwise, as would be the case if the vehicle that wants to exit is vehicle number 5 in frame A of FIG. 3. These semi-circular trajectories can cause vehicles to be in different directions in the same row, but this is completely irrelevant in terms of the functioning of the parking lot.

This usage of the buffer areas is not particularly efficient in terms of minimisation of travelling distance, but allows a simultaneous, platoon-based, mobility of vehicles, thus improving the overall exit time. As the manoeuvres are simple and standard, it also allows the derivation of an analytic expression that represents the average travelled distance for exiting vehicles under the full parking lot configuration. We consider ci to represent a vehicle that wants to exit from the i^{th} column (i−1 vehicles in front). It varies from 1 to

$$\frac{{N}_{c}}{2} = 5 ,$$

as we consider the symmetry on clockwise and anti-clockwise rotations. Thus the average travelling distance for exiting vehicles is:

$$\frac{{\sum }_{{c}_{i}}^{\frac{{N}_{c}}{2}} 2 ( {\sum }_{j = 1}^{{c}_{i} - 1} j γ + γ π ) + ( {N}_{c} - {c}_{i} - 1 ) γ + {c}_{i} γ + β}{\frac{{N}_{c}}{2}}$$

This gives approximately 143.85 m. Adding the average entry and park distance of 33.5 m, we obtain a total per vehicle of 177.35 m, which is similar to the 164 m in the conventional parking lot. Note that in the conventional parking lot the 164 m distance is fixed under all occupancy configurations of the parking lot, including nearly empty configurations. In the self-automated parking lot, the distance travelled in nearly empty configurations will be much smaller. Note also that a good parking strategy can minimise the exits of middle column vehicles, with important implications on the overall travelled distance.

The following pertains to the entry/exit dataset. To realistically evaluate the travelled distance in our proposal of a self-automated parking lot we have to resort to a dataset with the observed entries and exits of an existing parking lot. The type of parking lot in terms of its usage can significantly affect the performance of the algorithm managing the mobility of the cars. For instance, a shopping mall parking lot will have a higher rotation of vehicles, with shorter parking times per vehicle, when compared to a parking lot used by commuters during their working hours. An important parameter to the algorithm optimising the mobility of the cars in the parking lot is the expected exit time of each vehicle, given at entry time. This time can be inserted by the passenger or automatically predicted by the car, based on a self-learning process that captures the typical mobility pattern of its passenger [23].

Our dataset is constructed based on the video-recording of the activity of a parking lot during a continuous period of 24 hours. The parking lot in question is cost-free, which affects the parking pattern. It serves commute workers, as well as a nearby primary school, causing some shorter stops of parents who park their cars and walk their children to the school. This parking lot has a total of 104 parking spaces, which we reduced to 100 in order to match our 10×10 layout, by ignoring the entries and exits related with four specific parking spaces. This parking lot is continuously open. It only has one entry point and we thus only allow vehicles to enter our self-automated parking lot through the left side entrance. We start with an empty configuration of the parking lot, ending 24 hours later, with some vehicles still in the parking lot. Table 1 summarises the key facts in this dataset. A histogram with the distribution of entries and exits per 30 minutes intervals is provided in FIG. 4. The dataset is available as a Comma Separated Values (CSV) file through the following link: http://www.dcc.fc.up.pt/~michel/parking.csv.

TABLE 1
Key facts in the entry/exit dataset

| | |
|---|---|
| Parking lot location | (41.162745, −8.596255) |
| Start time | Dec 11th, 2013, 00:00 |
| Duration | 24 hours |
| Parking spaces | 100 |
| Total entries | 222 |
| Total exits | 209 |
| Average parking duration | 3 h 38 m 25 s |
| Average occupancy (0-24 h) | 34.76% |
| Average occupancy (9-17 h) | 74.59% |

The following pertains to conclusions. In this disclosure we present a concept of a self-automated parking lot, where autonomous cars use vehicular ad hoc networking to collaboratively move in order to accommodate entering vehicles and to allow the exit of blocked vehicles. Using this collaborative paradigm, the space needed to park each car can be reduced to nearly half the space needed in a conventional parking lot. This novel paradigm for the design of parking lots can have a profound impact on urban landscape, where the current area allocated to car parking can sometimes surpass 20%. Our proposal is particularly effective with the emergent paradigm of EV, where very high energy conversion efficiency is obtained at the low speeds observed in parking lot mobility.

Our proposal, however, needed to show that the overall collaborative mobility generated in such a self-automated parking lot is not prohibitively high, compared to the mobility in conventional parking lots. Using a real dataset of entries and exits in a parking lot during a 24 hour period, we have shown that even using a simple and non-optimised strategy to park vehicles, we are able to obtain a total travelled distance that can be 30% lower than in a conventional parking lot. This non-intuitive result further strengths the potential of our idea in re-designing the future of car parking.

Preferably, an optimisation can be used to estimate exit times to determine the original placement for each car which is able to further improve the results.

A possible implementation of the Collaborative parking system (CPS) can be realized by the system xx0 (Vehicle A) represented in FIG. 7. The system xx0 is composed of, for example, a vehicular communications system xx1, a positioning system xx2, an user interface xx3, software xx4, a processor xx5, a physical memory xx6, an interface to vehicle data xx7, and an interface to vehicle actuators xx8.

The Vehicular Communication System xx1 can support (bi-directional) short-range or long-range communication networks. Examples of short-range communications are ITS G5, DSRC, Device to Device (D2D) mode of cellular networks, WiFi, Bluetooth, among many others. Examples of supporting long-range communication networks are GSM, UMTS, LTE, WiMAX, its extensions (e.g. HSPDA), among many others, as well as combinations. The positioning system xx2 enables the determination of vehicles position in open space or confined spaces. Examples of positioning systems might include GPS, magnetic strips, WiFi, optical systems, cameras, among others, as well as combinations. The user interface xx3 enables the interaction between the user and the collaborative parking system. The Human interface can take a number of forms, namely through voice, a display, a keypad, motion sensors, cameras, among others, as well as combinations. The software module xx4 implements the automated parking functionalities. The functions included on the on-board system will depend whether a distributed mode or a centralized mode is considered. In the distributed mode, vehicles self-organize the parking structure through the collaborative movement of cars to allow the entry or exit or vehicles. In the centralized mode, vehicle receive, process and execute the instructions receive from a central entity. The software xx4 makes use of processor xx5 and memory/storage device xx6. The processor xx5 is also responsible for the interaction with other on-board systems, namely vehicle actuators xx7 and vehicle data systems xx8. Examples of vehicle actuators are steering, braking, engine, sensors, radar systems, among others. Examples of vehicle data systems are CAN, FlexRay, among others, as well as combinations.

System xx0 (Vehicle A) interacts with other vehicles—illustrated as system xx9 (Vehicle B)—directly through an ad hoc network and/or through a central entity, which can be part or external to a communication network. System xx0 can optionally interact with a computing system x10, located either at the parking lot or at a remote location, directly or indirectly (i.e. multi-hop communications) via an ad hoc network and/or through a central entity, which can be part or external to a communication network. Example information transferred from the vehicle to other the controller vehicle or the controlling computing system might be current vehicle position, status of the vehicle system (for example data collected from the vehicle data system xx8, such as speed, steering wheel parameters, engine status, among others), user input (for instance gathered from through or using the user interface xx3), software variables or status, among others. Example information transferred from the controlling unit, either a vehicle or a computing system, might include mobility instructions for individual vehicles, inter-vehicle coordination information, among others.

The collaborative parking system (CPS) can be implemented making use of any vehicle type in terms of automation level, engine type, among other types. Regarding the vehicle automation level, this can refer to, for example, autonomous vehicles, semi-autonomous vehicles or remotely controlled vehicles, or any combination of these or other automation levels. For clarification, the term remotely controlled vehicles refers, for instance, to vehicles that can be operated by a third party entity (e.g. a server or another vehicle) that have direct or indirect interface to the vehicle operation systems through technologies such as Drive-by-wire or Drive-by-wireless. Provided the necessary interfaces, the CPS is mostly independent of individual vehicle technologies (e.g. engine type) although in some cases selected technologies (e.g. electrical engines) can provide advantages (e.g. energy efficiency).

As will be appreciated by one skilled in the art, the collaborative parking system could be complemented or complement existing technologies advantageously under certain conditions. For example, the collaborative parking system could be complemented by Automated Valet Parking and/or automated robotic parking depending on specific conditions.

In addition, the collaborative parking system has been presented as most advantageous in a high density vehicle scenario, which might be associated with urban or suburban scenario. As will be appreciated by one skilled in the art, the collaborative parking system can be implemented in a number of scenarios including, but not limited to, heavy-duty (e.g. trucks) vehicle parks (e.g. along highways or distribution centers), ports/harbor facilities, etc.

In one embodiment with centralized approach, part of the software module xx4 functionalities may be implemented by the computing system x10 (“centralized approach”). FIG. 8 shows an example system aa0 (Server) for implementing these functionalities. System aa0 (Server) is composed of, for example, a (vehicular) communications system aa1, a processor aa2, an user interface aa3, software aa4, and physical memory/storage aa5. The elements aa1, aa2, aa3, aa4 and aa5 correspond to those of xx1, xx5, xx3, xx4 and xx6, respectively.

The computing task of aa0 can be performed by a single machine. Furthermore, as those skilled in the art will appreciate, the computing tasks of aa0 can be distributed or done in cooperation with other computing systems aa7 (Server, Computer, Computing Platform, etc.).

The following pertains to the initial stage with vehicle approaching. After presenting the overall system, in the following we describe in more detail different phases of the system functioning. Whenever a vehicle approaches a self-automated parking lot, it will communicate with a parking controller or its intermediary (e.g. a central server) to establish the initial parking operation. The initial parking operation might include a number of tasks, namely assisted vehicle path planning until the parking lot, vehicle access control, path planning inside the parking lot from the entrance until the parking spot and parking strategy determination to allow the vehicle entry in the compact parking structure. Upon entering the parking lot, the vehicle control is transferred from the current entity, (semi-) autonomous vehicle itself or third party, to the collaborative parking system (see FIG. 9).

The following pertains to the collaborative parking system (CPS) in what regards the communication vehicle→controller with periodic transmission of on-board vehicle information to parking lot controller (PLC) and occurs irrespective of entry/exit procedure, see FIG. 10.

The following pertains to the entry/exit procedure. See FIGS. 11 and 12. Example criteria for dd1 are minimum total travel distance, minimum total energy consumption, physical constraints (e.g. maximum turning radius), engine type, movement direction (forward or backward), exit time, among other, as well as their combinations. Example conditions for dd7 are vehicle blockage, vehicle anomaly, etc.

Example tie criteria might be topmost row, vehicle battery level, among others, as well as combinations. Example of step yy1 (for vehicle entry procedure) to determine all possible movement permutations between pairs of rows, subject to certain constraints (e.g. turning radius) (see FIG. 13).

The following pertains to the distributed functioning of the system. Regarding the leader election and handover, see FIG. 14. The leader election can be performed in a number of ways. For instance, leader election can resort to criteria such as battery level, computational capacity, reputation, among others, as well as combinations. Examples of Handover Conditions are vehicle exiting parking, geographical location, battery level, computational capacity and involvement in collaborative vehicle mobility, among others, as well as combinations.

The conflict resolution algorithm selects, for example, through consensus (e.g. voting) the vehicle to become leader for a given geographical area.

Regarding the inter-leader communication and coordination see FIG. 14. Under certain conditions (e.g. in the case of the distributed approach due to the limited communication range) the parking lot can be divided into a number of zones.

For instance, the division of the parking lot into a plurality of zones might be due to restrictions for vehicle circulations between zones (e.g. physical constraints such obstacles, ramps, among others). The zones can be static (e.g. defined by the parking lot operator or any other method) or dynamic when the zone shape, dimensions and other parameters are dependent/varied based on a number of conditions and/or criteria. In this scenario each zone is individually controlled by a Parking Lot Controller, which might need to coordinate the movement of vehicle between different zones. The coordination between different PLCs can be achieved through short range communications (e.g. ad hoc networks) or long range communication networks (e.g. cellular). The coordination between different zones might comprise i) transferal of vehicles between zones, ii) passage of vehicle (e.g. that are leaving) through zones, among other. These functions might be triggered by a number of criteria or conditions, namely the vehicles exit time, individual PLC optimization function, vehicle exit/entry, among others. In another embodiment, we consider also a dynamic mode, where zones are split, merged or coordinated depending on a number of criteria. Example criteria might be vehicle density, end of temporary restrictions, vehicle exit, among others, as well as combinations.

The following pertains to parking lot structures. The Collaborative Parking System might be implemented in a number of parking lot configurations. The geometric layout and its buffer areas can assume very different configurations. In addition, the exit and entry points for the compact parking zones might differ between sites but always considering an exit per parking zone. Vehicles might move forward or backward between lanes in a parking structure, or between lanes in different zones. Besides the matrix configuration presented previously we consider the following alternatives:
Cascade (15a) or interlinked (15b) parking, where vehicles move between different zones in a cascade fashion
Limited cascade parking, where vehicles between different zones but considering certain conditions (e.g. poles, ramps)
Circular or elliptical parking, where parking is done in circular structures (similar to nowadays roundabouts) or elliptical structures where vehicles are grouped into concentric circles; here actions such as inter-circle and circle entrance/exit operations are considered. As will be appreciated by one skilled in the art, other geometric shapes might be consider for the implementation of the system.
Spiral parking, where parking is done is spiral parking structures (e.g. nowadays access ramps) and vehicles move up and down these structure upon exit and entry of vehicles. Depending on the structure of the parking lot (e.g. in terms of exits), vehicle might enter in one enter on the top entrance and leave the bottom entrance, or vice-versa. Double spiral or other spiral structures might also be applicable

As will be appreciated by one skilled in the art, any combination of the previous example structures or other structures is considered. In addition, vehicle movement between different parking structures is also considered. A simple extension to the system considers an hierarchical mode, where the different zones are controlled in an hierarchical fashion.

The present disclosure describes a system for managing parking for semi-automated and automated vehicles comprising of

a controller for managing and coordinating a group of vehicles in parking and unparking maneuvers;
and a vehicle module for receiving, executing and reporting vehicle movements, both equipped with a communication system.

The present disclosure describes for self-automated parking lot for autonomous vehicles based on vehicular networking, comprising:

a parking lot controller for managing and coordinating a group of vehicles in parking and unparking maneuvers in said parking lot;
each of said vehicles comprising a vehicle electronic module for receiving, executing and reporting vehicle movements,
wherein said vehicle movements are sent by, and reported to, the parking lot controller,
the parking lot controller comprising a vehicular networking communication system for communicating with the communication system of the vehicle module.

In an embodiment, the parking lot controller is configured for:
moving autonomously in platoon one or more rows of already parked vehicles in order to make available a parking space for a vehicle arriving to the parking space; and
moving autonomously in platoon one or more rows of parked vehicles in order to make a parked vehicle able to exit the parking space.

In an embodiment, said communicating system includes using a vehicle-to-vehicle communication system.

In an embodiment, said communication system using a vehicle-to-vehicle communication system includes using a dedicated short-range communication protocol.

In an embodiment, said communication system using a vehicle-to-vehicle communication system includes using a mobile communications system.

In an embodiment, said communicating includes using a vehicle-to-infrastructure communication system.

In an embodiment, said communication system using a vehicle-to-vehicle communication system includes using a dedicated short-range communication protocol.

In an embodiment, said communication system using a vehicle-to-vehicle communication system includes using a mobile communications system.

In an embodiment, said controller includes

managing parking infrastructure access based on space availability;
managing vehicle movements upon entering parking infrastructure until the designated parking space is reached;
coordinating vehicle or vehicles movements to allow enter or exit of vehicle or vehicles in the parking area;
and a communication module for sending data de-scribing said vehicle movements.

In an embodiment, said controller functions are assumed by an elected vehicle.

In an embodiment, said controller functions are given to another vehicle just before the exit of the previous controller node.

In an embodiment, said controller functions are assumed by a local or remote server.

### BRIEF DESCRIPTION OF THE DRAWINGS

The following figures provide preferred embodiments for illustrating the description and should not be seen as limiting the scope of disclosure.

FIG. 1: Schematic representation of an embodiment with an example layout for a self-automated parking lot. Buffer areas are used to allow the transfer of a vehicle from one line to another line, 5 positions above or below, as illustrated by the dashed trajectory lines.

FIG. 2: Schematic representation of an embodiment with layout and travel distance in a conventional parking lot.

FIG. 3: Schematic representation of an embodiment with completely full parking lot. In this architecture, vehicles use the buffer areas to implement carrousels between lines 1-6, 2-7, 3-8, 4-9 and 5-10. Rotation can be clockwise or counter-clockwise.

FIG. 4: Schematic representation of a histogram presenting the number of entries and exits of cars per hour. We also plot the total number of cars in the parking lot. 100% occupancy is achieved at 16h05.

FIG. 5: Schematic representation of plots presenting the evolution of the total distance travelled throughout the 24 h analysed, both for the conventional parking lot and for the self-automated parking lot. Note how the non-optimised strategy causes a rapid increase on the curve for the self-automated parking lot around 16h00, when the parking lot is full and exits peak.

FIG. 6: Schematic representation of cumulative distribution function of distance per vehicle.

FIG. 7: Schematic representation of the collaborative parking system.

FIG. 8: Schematic representation of the CPS Computing System (x10 in FIG. 7).

FIG. 9: Schematic representation of the method for the initial stage with vehicle approaching.

FIG. 10: Schematic representation of the collaborative parking system (CPS) and respective communication between vehicle and controller.

FIG. 11: Schematic representation of Entry/exit procedure.

FIG. 12: Schematic representation of the method for determining vehicle movement strategy that optimizes a number of criteria.

FIG. 13: Schematic representation of example of step to determine all possible movement permutations between pairs of rows, subject to certain constraints (e.g. turning radius).

FIG. 14: Schematic representation of method for leader election and handover.

FIG. 15: Schematic representation of cascading and interlinking parking zones, connected by movement possibilities between rows of each zone.

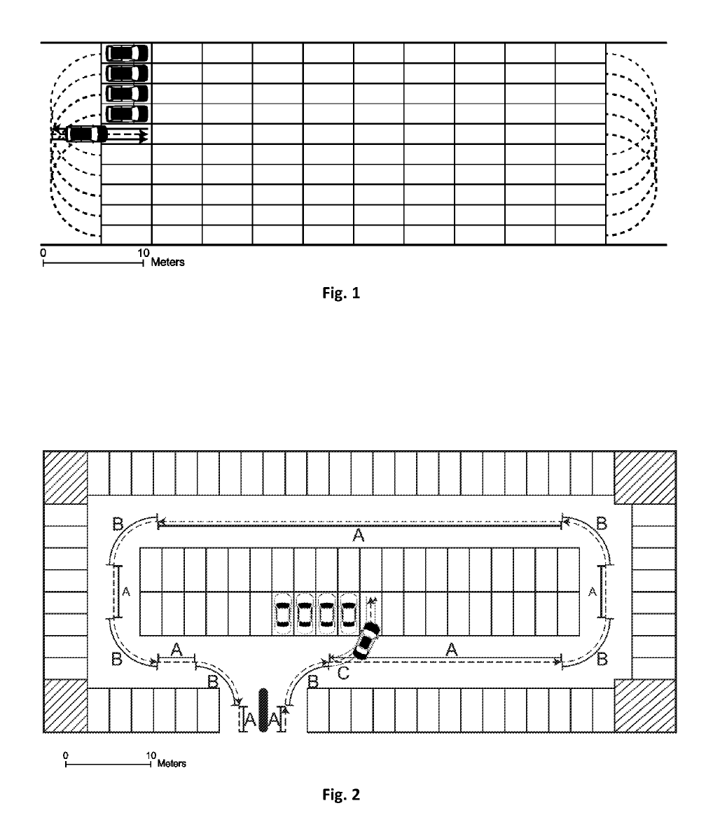

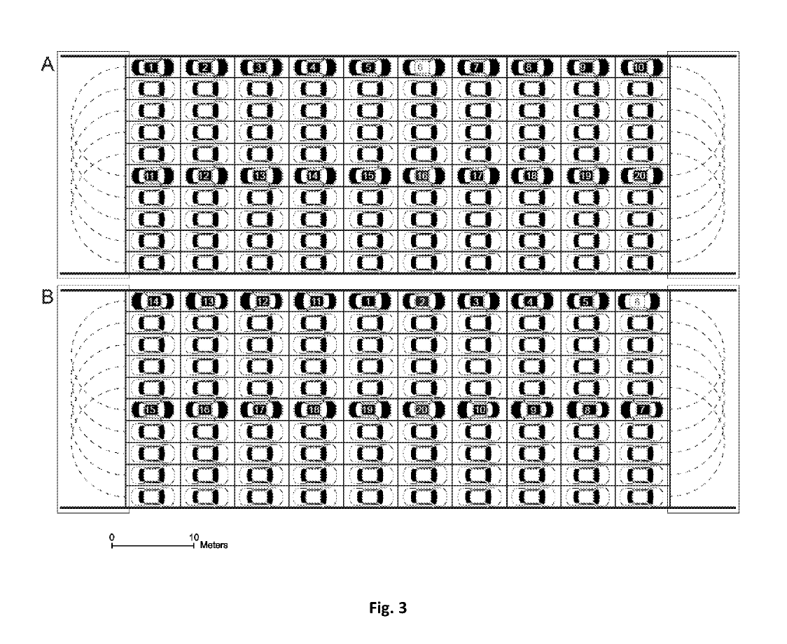

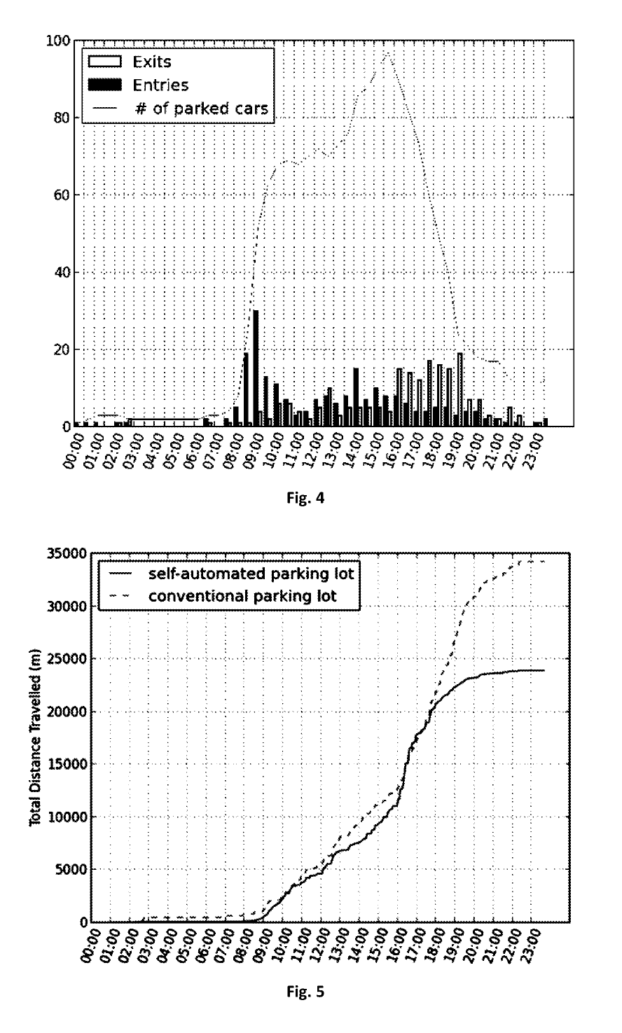

### DETAILED DESCRIPTION

The following also pertains to results. In an embodiment, we implement a simple strategy to park cars, ignoring the estimated exit time that would be given by each entering car. Our strategy is simply to place the car in the parking space that requires a minimal travel distance of the cars in the parking lot. No optimisation based on the estimated exit time is used. Our goal is to show that even with such non-optimised strategy the total travelled distance is significantly less than in a conventional parking lot. Clearly, an optimisation strategy that uses the estimated exit times to order the vehicles in monotonic sequences would be able to give better results.

The key metric that we evaluate is the total travelled distance of each vehicle, from entry time to exit time. Another possible metric would be the manoeuvring time. However, in our carrousel architecture vehicles are moved in platoon and thus total time is not affected by the number of vehicles in the platoon, but only by the distance travelled by the leading vehicle.

To measure this distance and to have a visual perspective of the functioning of the system, we implemented the self-automated parking lot architecture and mobility model using the Vehicular Networks Simulator (VNS) framework [24]. VNS was extended to model the specific features of our problem, namely the platoon-based mobility of vehicles. A video of this simulation under the dataset input is available through the following link: http://www.dcc.fc.up.pt/~rjf/animation.avi. The animation steps are based on the discrete entry and exit events, rather than on the continuous time, to eliminate dead periods.

The following pertains to total travelled distance. A plot with the total travelled distance during the 24 hours we analysed is presented in FIG. 5, with two series representing the conventional parking lot (dashed red line), and the self-automated parking lot (solid blue line).

As can be seen, the reduction observed in total travelled distance is very significant. In the self-automated parking lot, we obtained a total travelled distance of 23957.64 m, for the 222 vehicles entering the parking lot (note that 13 vehicles remain in the parking lot after we end the simulation at 23:59:59). Using the fixed value of ≈164 m for the conventional parking lot with the same number of entering and exiting vehicles, we obtain a total of 34, 261.24 m travelled distance, which translates into a reduction of 30%. Note that this reduction is obtained with a non-optimised strategy for parking vehicles. The non-optimised strategy affects primarily the performance during the period where the parking lot is nearly full (from 14h00 to 17h00), as the exits of middle-parked vehicles generates significant mobility of other parked vehicles, as can be seen in FIG. 5.

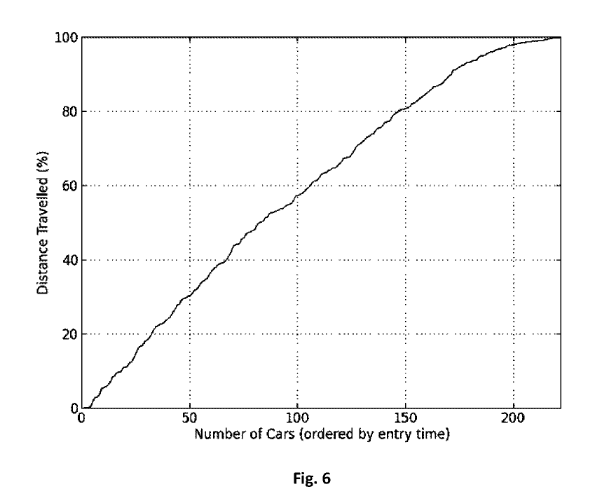

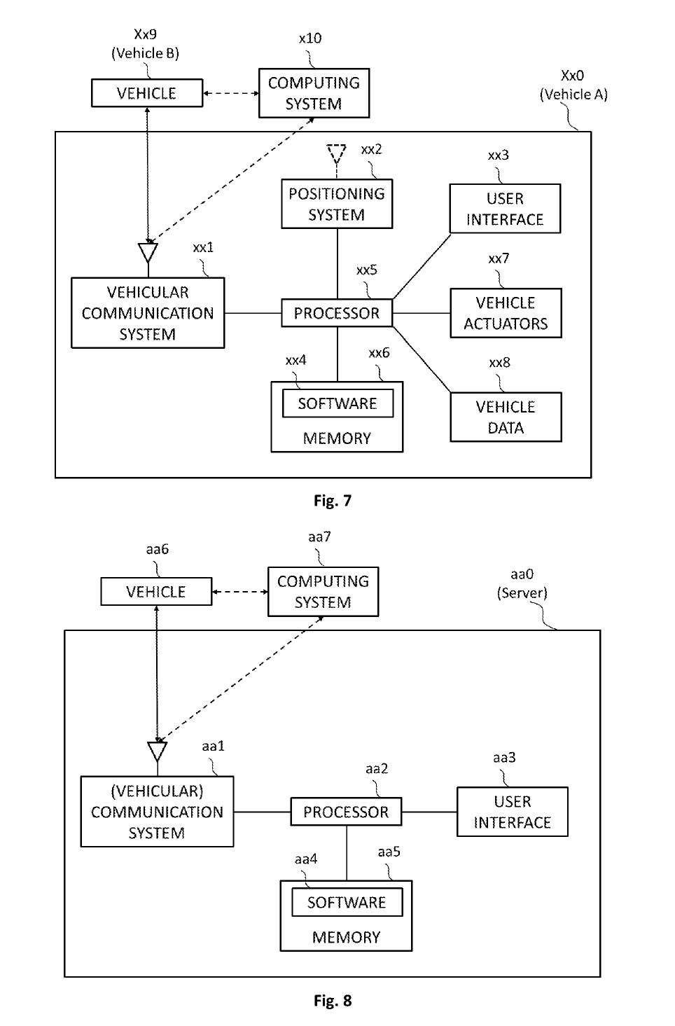

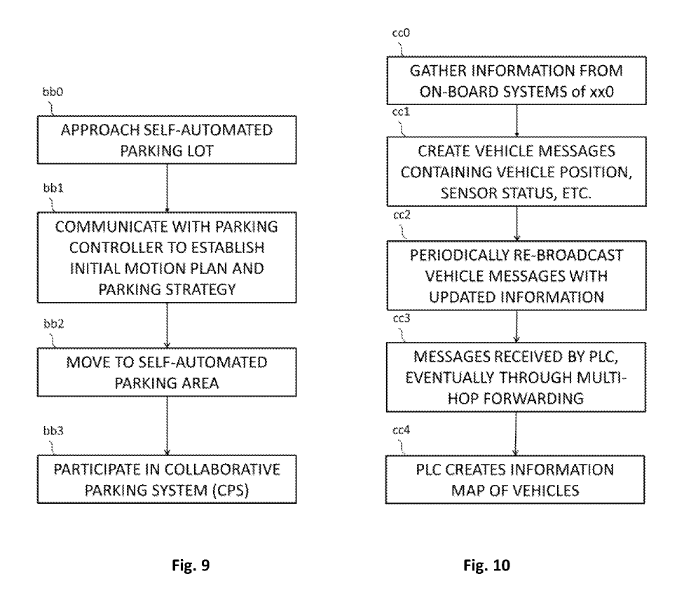

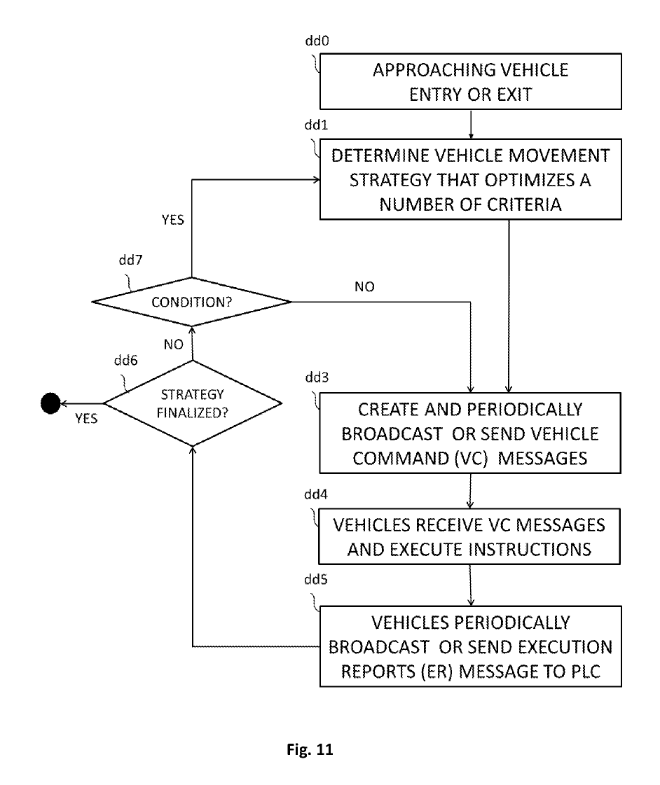

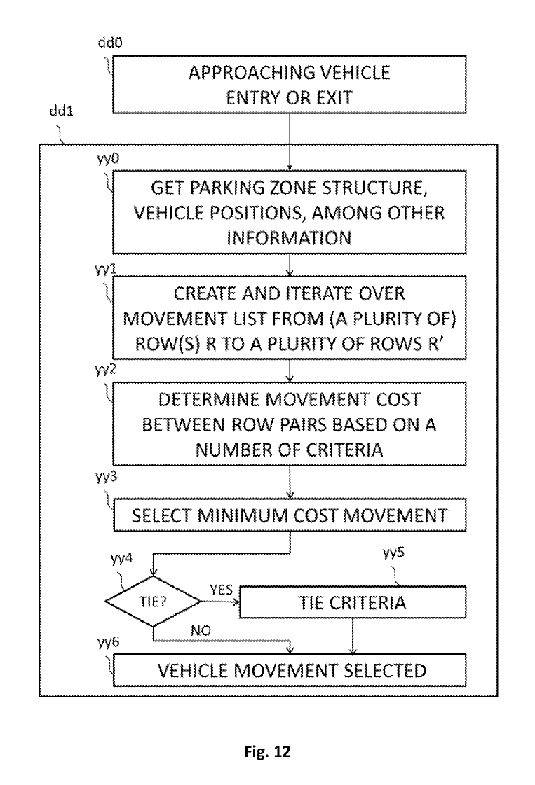

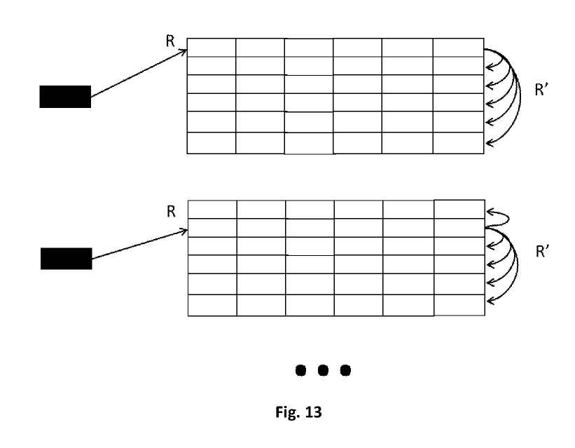

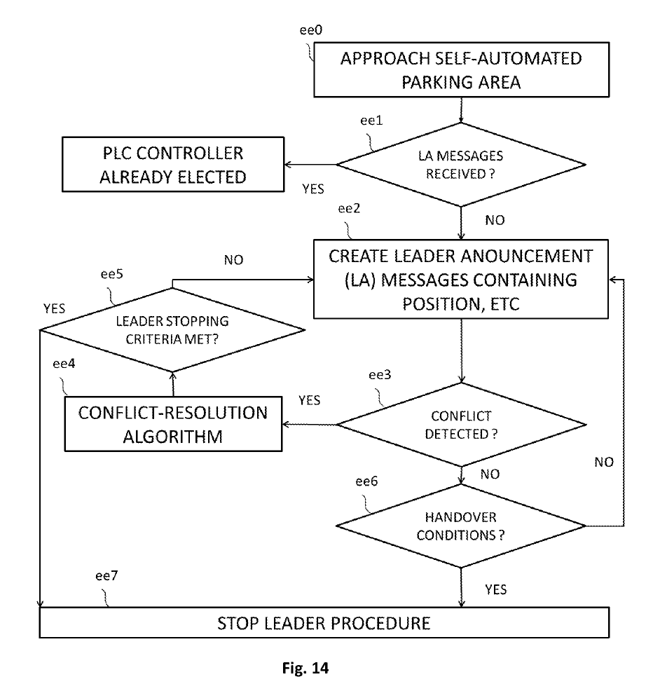

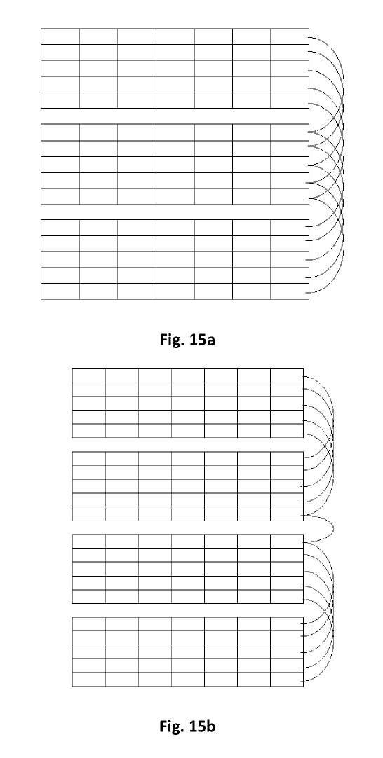

In Table 2 we present values for maximum travelled distance by a vehicle, average travelled distance and standard deviation. FIG. 6 shows the cumulative distribution function of distance per vehicle, where the linear behaviour is clear. Even the maximum value of 404 m travelled by a vehicle translates into less than $0.05 according to the average operating costs of a fuel-powered sedan in the USA [25]. Note that the vehicle that travelled 404 m stayed in the parking lot for approximately 16 h, resulting in an average travel of 25 m per hour, which translates into an operating cost of less than $0.003 per hour.

TABLE 2
Travelled distance statistics per vehicle

| | |
|---|---|
| Maximum travelled distance | 404 m |
| Average travelled distance | 112 m |
| Standard deviation | 87 m |

The term “comprising” whenever used in this document is intended to indicate the presence of stated features, integers, steps, components, but not to preclude the presence or addition of one or more other features, integers, steps, components or groups thereof.

Flow diagrams of particular embodiments of the presently disclosed methods are depicted in figures. The flow diagrams do not depict any particular means, rather the flow diagrams illustrate the functional information one of ordinary skill in the art requires to perform said methods required in accordance with the present disclosure.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

It is to be appreciated that certain embodiments of the disclosure as described herein may be incorporated as code (e.g., a software algorithm or program) residing in firmware and/or on computer useable medium having control logic for enabling execution on a computer system having a computer processor, such as any of the servers described herein. Such a computer system typically includes memory storage configured to provide output from execution of the code which configures a processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The disclosure should not be seen in any way restricted to the embodiments described and a person with ordinary skill in the art will foresee many possibilities to modifications thereof.

The above described embodiments are combinable.

The attached claims further set out particular embodiments of the disclosure.

1. A device for self-automated parking lot for autonomous vehicles based on vehicular networking, comprising:
a parking lot controller for managing and coordinating a group of vehicles in parking and unparking maneuvers in said parking lot;
each of said vehicles comprising a vehicle electronic module for receiving, executing and reporting vehicle movements,
wherein said vehicle movements are sent by, and reported to, the parking lot controller,
the parking lot controller comprising a vehicular networking communication system for communicating with the communication system of the vehicle module,
wherein the parking lot controller is configured for:
moving autonomously in platoon one or more rows of already parked vehicles in order to make available a parking space for a vehicle arriving to the parking space; and
moving autonomously in platoon one or more rows of parked vehicles in order to make a parked vehicle able to exit the parking space.

2. The device according to claim 1, wherein said vehicular communication system comprises a dedicated short-range communication protocol.

3. The device according to claim 1, wherein said vehicular communication system is a mobile communications system.

4. The device according to claim 1, wherein said vehicular communicating is a vehicle-to-infrastructure communication system.

5. The device according to claim 1, wherein said controller is further configured for:
managing parking infrastructure access based on space availability;
managing vehicle movements upon entering parking infrastructure until the designated parking space is reached;
coordinating vehicle or vehicles movements to allow enter or exit of vehicle or vehicles in the parking area; and
using a communication module for sending data describing said vehicle movements.

6. The device according to claim 5, wherein said parking lot controller is configured for also performing as vehicle module, when the parking lot controller functions are assumed by an elected vehicle where this vehicle module is placed.

7. The device according to claim 1, wherein said vehicle module is configured for transferring said parking lot controller functions to another vehicle module just before the exit of the parking lot of the controller.

8. The device according to claim 1, further comprising a positioning system for positioning the vehicle, a user interface for receiving and displaying user interactions, a connection to the vehicle actuators, computer readable memory and a computer processor.

9. The device according to claim 1, wherein said parking lot controller is a local or remote server.

10. The device according to the claim 9, further comprising a user interface for receiving and displaying user interactions, computer readable memory and a computer processor.

11. A method for operating a self-automated parking lot for autonomous vehicles based on vehicular networking,
said self-automated parking lot comprising a parking lot controller for managing and coordinating the vehicles in parking and unparking maneuvers in said parking lot, and
each vehicle comprising a vehicle electronic module for receiving, executing and reporting vehicle movements, wherein said vehicle movements are received from, and reported to, said parking lot controller by a communications system, said method comprising:
moving autonomously in platoon one or more rows of already parked vehicles in order to make available a parking space for a vehicle arriving to the parking space; and
moving autonomously in platoon one or more rows of parked vehicles in order to make a parked vehicle able to exit the parking space.

12. The method according to claim 11, further comprising:
moving autonomously in platoon two rows of vehicles such that vehicles move in carousel between the two rows, transferring vehicles of a first end of the first row of vehicles to a first end of the second row of vehicles, and transferring vehicles of the second end of the second row of vehicles to the second end of the first row of vehicles.

13. The method according to claim 11, further comprising:
moving autonomously in platoon one row of vehicles such that an empty parking space is obtained at one end of said row for receiving a vehicle entering the parking lot.

14. The method according to claim 11, further comprising:
moving autonomously in platoon two rows of vehicles such that vehicles move in carousel between the two rows, transferring vehicles of a first end of the first row of vehicles to a first end of the second row of vehicles, and transferring vehicles of the second end of the second row of vehicles to the second end of the first row of vehicles,
such that a vehicle exiting the parking lot is moved to one of the ends of one of the vehicle rows.

15. The method according to claim 11, further comprising:
on approaching the parking lot, the vehicle module communicating with the parking lot controller to signal the vehicle arrival and receiving a designated parking area;
subsequently, the parking lot controller generating, from a data map of the parking lot vehicles, a number of movements from one or more rows of vehicles to one or more rows of vehicles of the parking lot, then calculating the least costly movement and executing said movement by communicating said movement to the vehicle modules.

16. The method according to claim 11, further comprising:
the parking lot controller receiving vehicle position and sensor status data from the vehicle modules, creating a data map of the parking lot vehicles, periodically broadcasting vehicle modules with updates of said data.

17. The method according to claim 11, wherein the vehicle rows are linear, circular, elliptical, spiral, or combinations thereof.

18. The method according to claim 11, wherein the vehicle rows are grouped in cascading or interlinking parking zones such that only a part of the vehicle rows of one zone are able to exchange vehicles with the vehicle rows of another zone.

19. The method according to claim 11, wherein the parking lot controller is carried out by one of the vehicle electronic modules, in particular by electing a vehicle module by the vehicle modules by a set of predefined criteria, further in particular by resolving a conflict of tied vehicle modules by a set of predefined criteria.

20. A non-transitory storage media including program instructions for implementing a method for operating a self-automated parking lot for autonomous vehicles based on vehicular ad hoc networking, the program instructions including instructions executable to carry out the method of claim 11.
